(19) United States
(12) Patent Application Publication
(10) Pub. No.: US 2016/0257100 A1
(43) Pub. Date: Sep. 8, 2016

(54) LAMINATING APPARATUS AND IMAGE FORMING APPARATUS

(71) Applicant: CASIO COMPUTER CO., LTD., Tokyo (JP)

(72) Inventor: Seiji TACHIBANA, Tokyo (JP)

(73) Assignee: CASIO COMPUTER CO., LTD., Tokyo (JP)

(21) Appl. No.: 14/990,554

(22) Filed: Jan. 7, 2016

(30) Foreign Application Priority Data
Mar. 2, 2015 (JP) 2015-039933

(51) Int. Cl. B32B 37/00; B32B 37/10; G03G 15/00; B32B 37/06

(52) U.S. Cl. CPC B32B 37/0053; B32B 37/06; B32B 37/10; G03G 15/6585

(57) ABSTRACT

Two laminating films are placed on an upper paper feeding cassette and a manual feed tray, respectively, and a medium to be laminated is placed on a lower paper feeding cassette. These two laminating films are once stopped by coming in contact with a standby conveyance roller pair in a stopped state and the lamination target medium is stopped by being interposed between the two laminating films. Then, the two laminating films and the lamination target medium are integrally conveyed to a fuser by the standby conveyance roller pair and subjected to lamination processing by being heated and pressurized by the fuser.

### CROSS-REFERENCE TO RELATED APPLICATION

This application is based upon and claims the benefit of priority from the prior Japanese Patent Application No. 2015-039933, filed Mar. 2, 2015, the entire contents of which are incorporated herein by reference.

### BACKGROUND OF THE INVENTION

1. Field of the Invention

The present invention relates to a laminating apparatus and an image forming apparatus.

2. Description of the Related Art

Conventionally, in lamination processing of inserting and heat-welding printed material between laminating films, a pair of laminating films whose edges have been partially attached with each other and having a size conforming to that of the medium and a laminator (heat welding device) are required. This laminator is a device exclusive for welding pairs of laminating films.

Also, a technology is known in which a laminating film roll for upper surfaces and a laminating film roll for lower surfaces are provided, and printed material is conveyed between these laminating films, bonded by thermocompression, and cut when processing for one sheet is completed (for example, Japanese Patent Application Laid-Open (Kokai) Publication No. 03-110128).

Moreover, a technology is known in which printed material interposed between laminating films are fed from a manual feeder and bonded by thermocompression using an electrophotographic copier (copy machine) instead of an exclusive laminator (for example, Japanese Patent Application Laid-Open (Kokai) Publication No. 62-297859).

### SUMMARY OF THE INVENTION

In accordance with one aspect of the present invention, there is provided a laminating apparatus comprising: a first accommodation section which accommodates a first laminating film; a second accommodation section which accommodates a second laminating film; a third accommodation section which accommodates a lamination target medium; a heating and pressurizing section which is provided on a lower flow side with respect to a standby conveyance roller pair in a conveying direction; and a conveying section which (i) conveys the first laminating film supplied from the first accommodation section and the second laminating film supplied from the second accommodation section until a tip end of the first laminating film and a tip end of the second laminating film come in contact with the standby conveyance roller pair, with the standby conveyance roller pair being stopped, (ii) conveys the lamination target medium supplied from the third accommodation section to an area between the first laminating film and the second laminating film in contact with and stopped by the standby conveyance roller pair, and (iii) drives the standby conveyance roller pair to convey the first laminating film, the second laminating film, and the lamination target medium interposed between the first laminating film and the second laminating film to the heating and pressurizing section.

In accordance with one aspect of the present invention, there is provided a laminating apparatus comprising: a first conveyance path for conveying a first accommodated object placed on a first accommodation section to a standby conveyance roller pair; a second conveyance path for conveying a second accommodated object placed on a second accommodation section to the standby conveyance roller pair; a third conveyance path for conveying a third accommodated object placed on a third accommodation section to the standby conveyance roller pair; a heating and pressurizing section which is provided on a lower flow side with respect to the standby conveyance roller pair in a conveying direction; and a control section which (i) conveys the first accommodated object, the second accommodated object, and the third accommodated object to the standby conveyance roller pair by the first conveyance path, the second conveyance path, and the third conveyance path, respectively, with the standby conveyance roller pair being stopped, in such a manner that at least a tip end of the second accommodated object is interposed between the first accommodated object and the third accommodated object, (ii) drives the standby conveyance roller pair after conveying the first accommodated object, the second accommodated object, and the third accommodated object to the standby conveyance roller pair, and (iii) conveys the first accommodated object, the third accommodated object, and the second accommodated object interposed between the first accommodated object and the third accommodated object to the heating and pressurizing section.

In accordance with one aspect of the present invention, there is provided an image forming apparatus comprising: a switching section which switches between a printing mode and a laminating mode; a first conveyance path for conveying a first accommodated object placed on a first accommodation section to a standby conveyance roller pair; a second conveyance path for conveying a second accommodated object placed on a second accommodation section to the standby conveyance roller pair; a third conveyance path for conveying a third accommodated object placed on a third accommodation section to the standby conveyance roller pair; a control section which drives the standby conveyance roller pair after conveying the first accommodated object, the second accommodated object, or the third accommodated object to the standby conveyance roller pair; and a fixing section which is provided on a lower flow side with respect to the standby conveyance roller pair in a conveying direction, wherein the control section, when a current mode is switched to the laminating mode by the switching section, (i) conveys the first accommodated object, the second accommodated object, and the third accommodated object to the standby conveyance roller pair by the first conveyance path, the second conveyance path, and the third conveyance path, respectively, with the standby conveyance roller pair being stopped, in such a manner that at least a tip end of the second accommodated object is interposed between the first accommodated object and the third accommodated object, (ii) conveys the first accommodated object, the second accommodated object, and the third accommodated object to the standby conveyance roller pair, and then (iii) conveys the first accommodated object, the third accommodated object, and the second accommodated object interposed between the first accommodated object and the third accommodated object to the fixing section.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention can be more deeply understood by the detailed description below being considered together with the following drawings.

FIG. 1 is a sectional view showing the inner structure of an image forming apparatus according to an embodiment of the present invention;

FIG. 2 is a block diagram showing the structure of a partial control system of the image forming apparatus according to the present embodiment;

FIG. 3 is a flowchart for explaining operations (lamination processing) of the image forming apparatus according to the present embodiment; and

FIG. 4 is a schematic diagram for explaining operation processes of the image forming apparatus according to the present embodiment.

### DETAILED DESCRIPTION OF THE PREFERRED EMBODIMENT

An embodiment of the present invention will hereinafter be described with reference to the drawings.

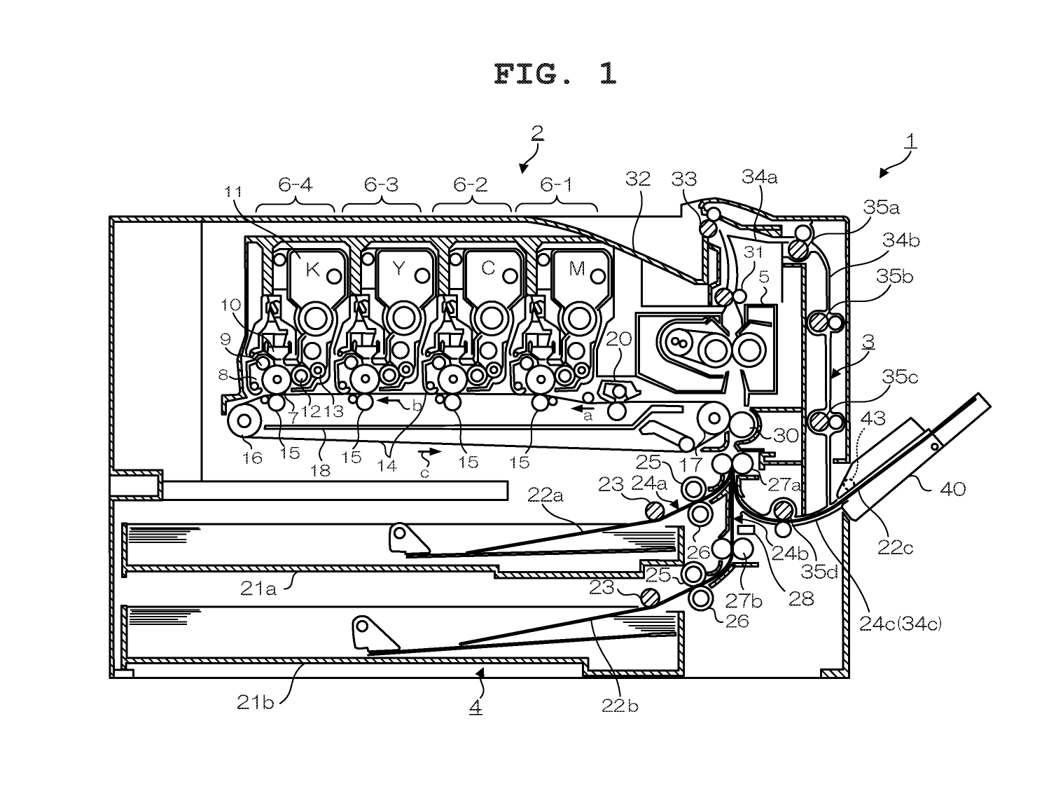

FIG. 1 is a sectional view showing the inner structure of an image forming apparatus 1 according to an embodiment of the present invention, which is also applicable as a laminating apparatus. The image forming apparatus 1 of the present embodiment in FIG. 1 is not an apparatus that directly transfers a toner image to paper (print target medium) but an apparatus that transfers a toner image to an intermediate transfer belt once and secondarily transfers the toner image to paper vertically conveyed to a secondary transfer section via the intermediate transfer belt.

This image forming apparatus 1 includes an image forming section 2, a two-sided printing conveyance unit 3, a paper feeding section 4 and a fuser 5. The image forming section 2 has a structure where four image forming units 6 (6-1, 6-2, 6-3, 6-4) have been provided side-by-side in multiple stages. The top three image forming units 6-1, 6-2 and 6-3 form mono-color images using color toners of magenta (M), cyan (C), and yellow (Y) serving as subtractive primary colors. The fourth image forming unit 6-4 subsequent to these three image forming units 6-1, 6-2 and 6-3 forms a monochrome image in black (K). The toner images in the four colors are overlaid on paper to form a full-color image.

The image forming units 6-1 to 6-4 have the same structures except for the color and the type of a developer contained in a developing unit. Therefore, their structures will be described using the structure of the image forming unit 6-4 as an example.

The image forming unit 6 has a photosensitive drum 7 in its lowermost portion. The peripheral surface of this photosensitive drum 7 is formed of, for example, an organic photoconductive material, and a cleaner 8, a charging roller 9, an optical writing head 10, and a developing roller 12 in a developing device 11 are arranged to come in contact with the peripheral surface of the photosensitive drum 7 or surround the vicinity thereof.

The developing device 11 has in its upper portion a toner container containing the toner of one of magenta (M), cyan (C), yellow (Y), and black (K) indicated by T, M, C, Y, and K in the drawing, and has in its intermediate portion a toner replenishing mechanism oriented downward.

The developing device 11 includes the above-described developing roller 12 in a lateral opening in its lower portion, and has in its inner portion a toner agitating member, a toner supply roller 13 for supplying toner to the developing roller 12, a doctor blade for regulating a toner layer on the developing roller 12 to a predetermined layer thickness, and the like. The optical writing head 10 on the apparatus body side is arranged in proximity to the upper surface of the photosensitive drum 7 between the charging roller 9 and the developing device 11.

Also, in an area near the lower surface of the photosensitive drum 7, an intermediate transfer belt 14 is arranged, and a primary transfer roller 15 is pressed toward the lower surface of the photosensitive drum 7 with the intermediate transfer belt 14 being interposed therebetween.

The intermediate transfer belt 14 is an endless-shaped transfer belt constituted by a conductive sheet-like member made of resin containing conductive carbon or an ion conductive material and extending in a flat loop shape substantially from the left end to the right end at a center portion of the apparatus body in the drawing. The intermediate transfer belt 14 is stretched between a driving roller 16 and a follower roller 17, and is cyclically driven in the counterclockwise direction in the drawing by the driving roller 16 so as to cyclically move in the counterclockwise direction indicated by arrows a, b, and c in the drawing.

The photosensitive drum 7 rotates in the clockwise direction in the drawing. First, this photosensitive drum 7 is initialized when the peripheral surface of the photosensitive drum 7 is uniformly charged by electric charge from the charging roller 9. Subsequently, an electrostatic latent image is formed on the peripheral surface of the photosensitive drum 7 by optical writing from the optical writing head 10 based on printing information.

Then, the electrostatic latent image is changed to a toner image (developed) using toner contained in the developing device 11 by development processing by the developing roller 12. Subsequently, the toner image acquired by the development onto the peripheral surface of the photosensitive drum 7 is directly transferred (primarily transferred) to the belt surface of the intermediate transfer belt 14 by the primary transfer roller 15 along with the rotation of the photosensitive drum 7. Then, the intermediate transfer belt 14 is conveyed to a transfer position where transfer to paper is performed so as to further transfer (secondarily transfer) the toner image directly transferred (primarily transferred) to the belt surface.

A belt position control mechanism 18 in FIG. 1 includes the primary transfer roller 15 constituted by a conductive foamed sponge that is pressed against the lower peripheral surface of the photosensitive drum 7 via the intermediate transfer belt 14. This belt position control mechanism 18 rotationally moves the three primary transfer rollers 15 respectively corresponding to the three image forming units 6-2, 6-3, and 6-4 in magenta (M), cyan (C), and yellow (Y) in the same period with a hook-type support shaft as its center. Also, the belt position control mechanism 18 rotationally moves one primary transfer roller 15 corresponding to the image forming unit 6-4 in black (K) in a rotational movement period different from the period of the three primary transfer rollers 15 so that the intermediate transfer belt 14 comes in contact with or separates from the photosensitive drum 7.

More specifically, the belt position control mechanism 18 switches the position of the intermediate transfer belt 14 to a position for a full-color mode (all of the four primary transfer rollers 15 come in contact with the intermediate transfer belt 14), a position for a monochrome mode (only the primary transfer roller 15 corresponding to the image forming unit 6-4 comes in contact with the intermediate transfer belt 14) and a position for a complete non-transfer mode (all of the four primary transfer rollers 15 separate from the intermediate transfer belt 14).

The paper feeding section 4 includes paper feeding cassettes 21a, 21b as two accommodation sections arranged vertically in two stages. When data is to be printed on paper, a plurality of sheets of cut paper is accommodated in one or both of the paper feeding cassettes 21a, 21b of the paper feeding section 4. On the other hand, when lamination processing is to be performed, laminating films 22a are accommodated in the upper paper feeding cassette 21a with their welding layers facing downward (welding layers facing towards a placement surface) and lamination target media 22b are accommodated in the lower paper feeding cassette 21b. In this example, some types of designs have been printed in advance on the lamination target media 22b using the image forming apparatus 1. Note that, in the following descriptions, a case where lamination processing is to be performed (laminating films 22a and 22c and lamination target media 22b) will be explained in detail while explanations of operations for printing processing on paper will be partially omitted.

In the vicinity of paper feeding openings (right side in the drawing) of the two paper feeding cassettes 21a and 21b, a paper feeding roller 23, a feeding roller 25, a separation roller 26 and standby conveyance roller pairs 27a and 27b are provided. Also, a tip end detection sensor 28 for detecting tip ends of the lamination target media 22b is arranged on a conveyance path from the paper feeding cassette 21b accommodating the lamination target media 22b towards the standby conveyance roller pair 27b on the lower flow side.

In addition, a MPF (Multi Paper Feeder) tray 40 is fitted as an accommodation section into a fitting section opened at the image forming apparatus 1. The MPF tray 40 is a so-called manual feed tray. In printing on paper, sheets of paper with unique thickness or size are mounted on the MPF tray 40. On the other hand, in lamination processing, the laminating films 22c are mounted on the MPF tray 40 with their welding layers facing downward (with welding layers opposing the placement surface).

The laminating film 22a is conveyed and supplied sheet by sheet from the paper feeding cassette 21a by a single rotation of the paper feeding roller 23, passes through the feeding roller 25 and the separation roller 26, and is fed to the standby conveyance roller pair 27a. Similarly, the laminating film 22c is conveyed and supplied from the MPF tray 40 by a single rotation of a paper feeding roller 43 and is fed to the standby conveyance roller pair 27a via an end return path 34c and a return roller pair 35d described later. On the other hand, the lamination target medium 22b is conveyed and supplied sheet by sheet from the paper feeding cassette 21b by a single rotation of the paper feeding roller 23 at timing shifted from the start of the conveyance of the above-described laminating films 22a and 22c, passes through the feeding roller 25, the separation roller 26, and the standby conveyance roller pair 27a, and is fed to the standby conveyance roller pair 27a.

As shown in FIG. 1, the conveyance path 24a from the paper feeding cassette 21a to the standby conveyance roller pair 27a, the conveyance path 24b from the paper feeding cassette 21b to the standby conveyance roller pair 27a, and the conveyance path 24c from the MPF tray 40 to the standby conveyance roller pair 27a are different from one another. More specifically, the laminating film 22a passes through the conveyance path 24a by which it reaches the standby conveyance roller pair 27a from the left side in the drawing, and the laminating film 22c passes through the conveyance path 24c (namely the end return path 34c) by which it reaches the standby conveyance roller pair 27a from the right side in the drawing. The lamination target medium 22b passes between the laminating films 22a and 22c and passes through the conveyance path 24b by which it reaches the front of the standby conveyance roller pair 27a.

Here, the standby conveyance roller pair 27a maintains the stopped state. Accordingly, the laminating films 22a and 22c pass through their respective conveyance paths 21a and 24c and are once stopped when their tip ends come in contact with the standby conveyance roller pair 27a. As described above, since the laminating films 22a and 22c respectively remain in their conveyance paths 24a, 24c with their tip ends being in contact with the standby conveyance roller pair 27a, not the entire surfaces but only their tip end portions come in close contact, and portions other than the tip ends are in open states.

On the other hand, the lamination target medium 22b supplied from the lower-staged paper feeding cassette 21b at shifted timing passes through the conveyance path 24b, proceeds by being interposed between the laminating films 22a and 22c in contact with the standby conveyance roller pair 27a, and stops just before it comes in contact with the standby conveyance roller pair 27a. Accordingly, it is possible to secure a margin for heat welding (a margin around the lamination target medium 22b).

Thereafter, when the lamination target medium 22b enters a state of being interposed between the laminating films 22a and 22c, the standby conveyance roller pair 27a is driven. Then, the laminating film 22a, the lamination target medium 22b and the laminating film 22c are integrally conveyed towards a conveyance path on the lower flow side described later by means of the standby conveyance roller pair 27a.

In the paper conveying direction of the standby conveyance roller pair 27a (vertical upper direction in the drawing: lower flow side), a secondary transfer roller 30 that comes in pressure contact with the follower roller 17 via the intermediate transfer belt 14 is arranged. By the intermediate transfer belt 14, the follower roller 17, and this secondary transfer roller 30, a secondary transfer section for secondary transfer to paper is formed. In the present embodiment, in lamination processing, the apparatus enters the above-described complete non-transfer mode (all of the four primary transfer rollers 15 separate from the intermediate transfer belt 14), and primary transfer and secondary transfer are not performed.

The fuser 5 including a belt-type thermal fixing unit as the heating and pressuring section is arranged on the lower flow side (on the upper side in the drawing) of the secondary transfer section. A conveyance roller pair 31 which conveys paper after fixing from the fuser 5, and a paper ejection roller pair 33 which ejects the conveyed paper to a paper ejection tray 32 formed on the upper surface of the apparatus are arranged on the further lower flow side of the fuser 5. In the present embodiment, lamination processing is performed by bonding the lamination target media 22b interposed between the laminating films 22a and 22c by thermocompression by means of the fuser 5.

The two-sided printing conveyance unit 3 includes a return path branched in the right lateral direction in the drawing from a conveyance path in an intermediate portion between the conveyance roller pair 31 and the paper ejection roller pair 33. This return path includes a start return path 34a, an intermediate return path 34b bent downward, the end return path 34c bent in the left lateral direction for conclusively reversing returned paper, and four return roller pairs 35a, 35b, 35c, and 35d arranged halfway in the return paths. An outlet of the end return path 34c connects to a conveyance path directed toward the standby conveyance roller pair 27a corresponding to the paper feeding cassette 21a in an upper area in the paper feeding section 4.

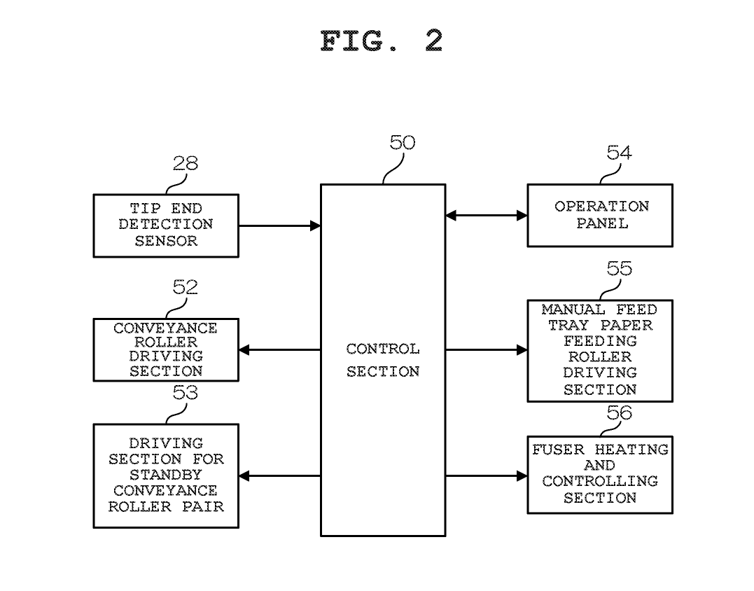

FIG. 2 is a block diagram showing the structure of a partial control system of the image forming apparatus 1 according to the present embodiment. Note that sections corresponding to those in FIG. 1 are provided with the same reference numerals, and explanations thereof are omitted. In FIG. 2, the image forming apparatus 1 includes the tip end detection sensor 28, a control section 50, a conveyance roller driving section 52, a driving section for the standby conveyance roller pair 53, an operation panel 54, a manual feed tray paper feeding roller driving section 55 and a fuser heating and controlling section 56.

The tip end detection sensor 28 detects the passage of tip ends of lamination target media 22b based on the transmissivity of transmitted light with respect to the lamination target media 22b or based on changes in the reflectance of reflected light. The conveyance roller driving section 52 is controlled by the control section 50 to drive the group of rollers other than the standby conveyance roller pair 27a, that is, the paper feeding roller 23, the feeding roller 25, the separation roller 26, the conveyance roller pair 31, the paper ejection roller pair 33 and the return roller pairs 35a, 35b, 35c, and 35d and the like. The driving section for the standby conveyance roller pair 53 is controlled by the control section 50 to drive the standby conveyance roller pair 27a.

The operation panel 54 is constituted by, for example, ten keys and function keys or a touch panel for inputting the number of prints, an instruction to perform single-sided/two-sided printing, or an instruction to perform lamination processing and the like and for displaying operating conditions and settings. The manual feed tray paper feeding roller driving section 55 is controlled by the control section 50 to drive the paper feeding roller 43 or the return roller pair 35d when the laminating films 22c are supplied from the MPF tray 40. The fuser heating and controlling section 56 is controlled by the control section 50 to control the heating/stopping of the fuser 5.

The control section 50 integrally controls operations of the above-described sections. Particularly, in the present embodiment, there are provided a printing mode in which toner images are transferred to and developed on print target media placed on the paper feeding cassette 21a, the paper feeding cassette 21b, or the MPF tray 40, and a laminating mode in which lamination target media 22b placed on the paper feeding cassette 21b are interposed between laminating films 22a and 22c placed on the paper feeding cassette 21a and the MPF tray 40 and laminated. Switching between the printing mode and the laminating mode can be performed by, for example, the operation of the operation panel 54.

In the printing mode, the control section 50 controls the timing of supplying print target media serving as accommodated objects placed on the paper feeding cassette 21a, the paper feeding cassette 21b, or the MPF tray 40 using the conveyance roller driving section 52 and the manual feed tray paper feeding roller driving section 55. In the laminating mode, the control section 50 controls the timing of supplying the laminating films 22a and 22c serving as accommodated objects placed on the paper feeding cassette 21a and the MPF tray 40 and the lamination target media 22b serving as accommodated objects placed on the paper feeding cassette 21b by using the conveyance roller driving section 52 and the manual feed tray paper feeding roller driving section 55. Particularly, in the laminating mode, the control section 50 performs control to supply the laminating films 22a and 22c placed on the paper feeding cassette 21a and the MPF tray 40 and then supplies the lamination target media 22b placed on the paper feeding cassette 21b at predetermined timing.

Also, in the printing mode, the control section 50 controls the timing of conveyance by the standby conveyance roller pair 27a by using the driving section for the standby conveyance roller pair 53 in order to transfer toner images from the secondary transfer roller 30 to print target media. In the laminating mode, the control section 50 controls the timing of conveyance by the standby conveyance roller pair 27a by using the driving section for the standby conveyance roller pair 53 in order to convey the laminating films 22a and 22c in contact with each other at the standby conveyance roller pair 27a and the lamination target media 22b interposed between these laminating films 22a and 22c to the fuser 5 integrally.

Moreover, in the printing mode, the control section 50 sets the current mode to the full color mode (all of the four primary transfer rollers 15 come in contact with the intermediate transfer belt 14) or the monochrome mode (only the primary transfer roller 15 corresponding to the image forming unit 6-4 comes in contact with the intermediate transfer belt 14) and controls the heating/stopping of the fuser 5 by using the fuser heating and controlling section 56 for fixing transferred toner images by heating and pressurizing the print target media. In the laminating mode, the control section 50 sets the current mode to the complete non-transfer mode (all of the four primary transfer rollers 15 separate from the intermediate transfer belt 14) and controls the heating/stopping of the fuser 5 by using the fuser heating and controlling section 56 for compressing the laminating films 22a, the lamination target media 22b and the laminating films 22c conveyed in a layered state by heating and pressurizing. Note that details of the control in the laminating mode will be described later.

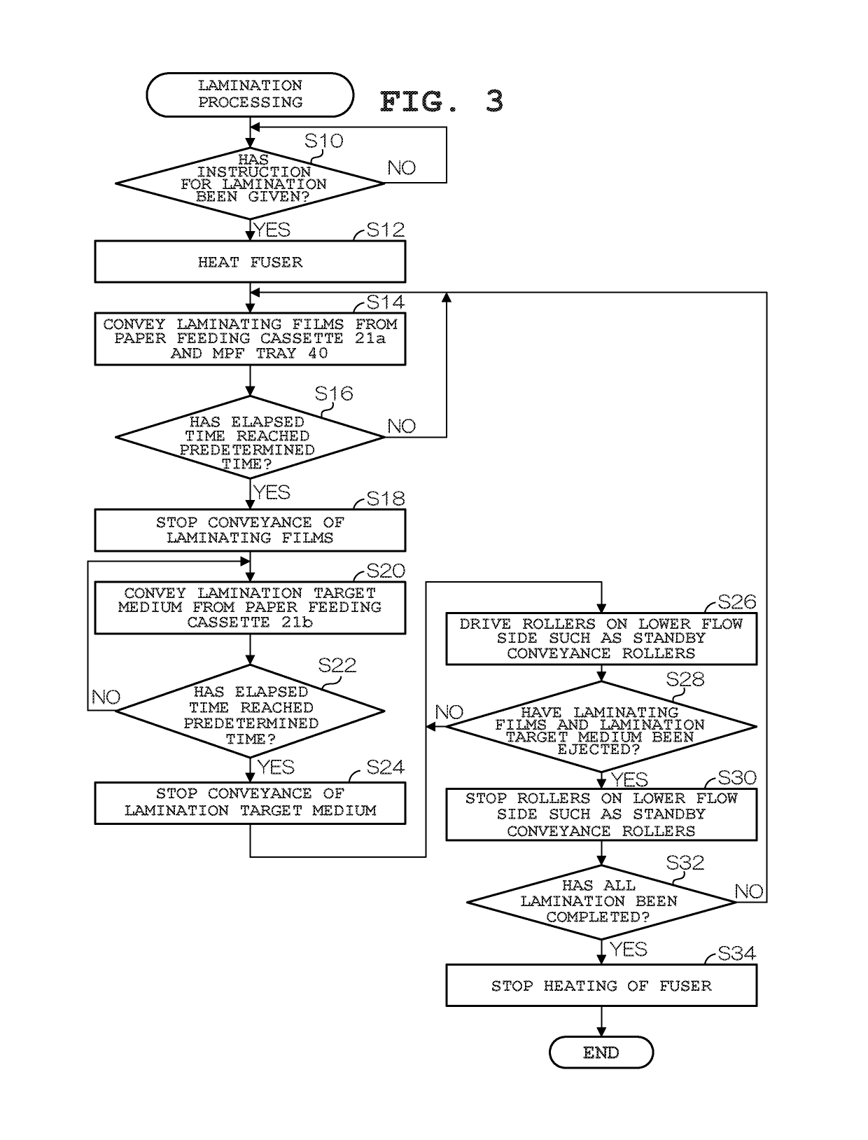

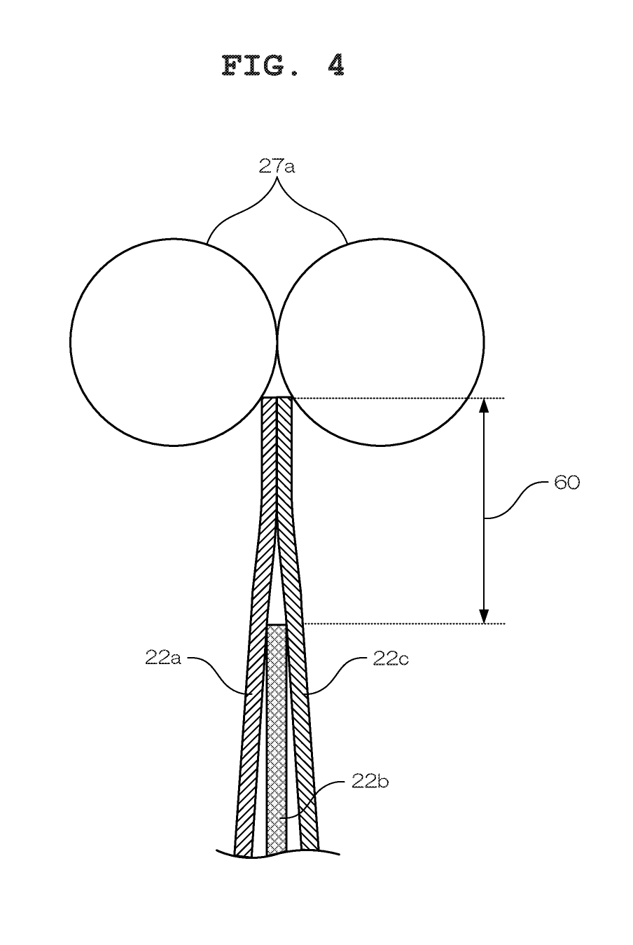

FIG. 3 is a flowchart for explaining operations (lamination processing) of the image forming apparatus 1 according to the present embodiment, and FIG. 4 is a schematic diagram for describing operation processes of the image forming apparatus 1 according to the present embodiment. First, the operator places a desired number of the laminating films 22a and 22c on the paper feeding cassette 21a and the MPF tray 40 in a manner to face up their film surfaces, and places the lamination target media 22b on the paper feeding cassette 21b. Then, the operator inputs an instruction to perform lamination processing (an instruction to switch the current mode to the laminating mode) by using the operation panel 54.

Then, the control section 50 judges whether an instruction to perform lamination processing has been inputted using the operation panel 54 (Step S10). When judged that no instruction to perform lamination processing has been inputted (NO at Step S10), the control section 50 enters a standby state (or in a state for performing other processing). Conversely, when judged that an instruction to perform lamination processing has been inputted (YES at Step S10), the control section 50 performs control to heat the fuser 5 to a predetermined temperature using the fuser heating and controlling section 56 (Step S12).

Next, the control section 50 starts the conveyance of the laminating films 22a and 22c from the paper feeding cassette 21a and the MPF tray 40 via the conveyance roller driving section 52 (Step S14). Accordingly, the laminating films 22a and 22c respectively pass through the conveyance path 24a and the conveyance path 24c to be conveyed towards the standby conveyance roller pair 27a. When the conveyance of the laminating films 22a and 22c is started, the control section 50 judges whether the time elapsed from the start of the conveyance of the laminating films 22a and 22c has reached a predetermined time (Step S16).

More specifically, the control section 50 starts the conveyance of the laminating films 22a and 22c with the standby conveyance roller pair 27a being stopped, and judges that tip ends of the laminating films 22a and 22c have come in contact with the standby conveyance roller pair 27a when the time elapsed from the start of the conveyance of the laminating films 22a and 22c has reached a predetermined time measured in advance in the design phase.

When judged that the time elapsed from the start of the conveyance of the laminating films 22a and 22c has not reached the predetermined time (NO at Step S16), the control section 50 judges that tip ends of the laminating films 22a and 22c have not come in contact with the standby conveyance roller pair 27a and returns to Step S14 to continue the conveyance of the laminating films 22a and 22c. That is, the control section 50 continues the conveyance of the laminating film 22a of the paper feeding cassette 21a until it comes in contact with the standby conveyance roller pair 27a, and also continues the conveyance of the laminating film 22c of the MPF tray 40 until it comes in contact with the standby conveyance roller pair 27a.

Conversely, when judged that the time elapsed from the start of the conveyance of the laminating films 22a and 22c has reached the predetermined time (YES at Step S16), the control section 50 judges that tip ends of the laminating films 22a and 22c have come in contact with the standby conveyance roller pair 27a, and stops the conveyance of the laminating films 22a and 22c via the conveyance roller driving section 52 and the manual feed tray paper feeding roller driving section 55 (Step S18). Here, the tip ends of the two laminating films 22a and 22c are in contact with the standby conveyance roller pair 27a in a substantially aligned state.

Next, the control section 50 starts conveying the lamination target medium 22b placed on the paper feeding cassette 21b via the conveyance roller driving section 52 (Step S20). The lamination target medium 22b passes through the conveyance path 24b between the two laminating films 22a and 22c to be conveyed towards the standby conveyance roller pair 27a. Here, the control section 50 monitors whether the passage of a tip end of the lamination target medium 22b has been detected by the tip end detection sensor 28 and, when judged that a tip end of the lamination target medium 22b has passed, starts a clocking operation to count the time elapsed from the passage.

Next, the control section 50 judges whether the time elapsed after the passage of the tip end of the lamination target medium 22b has reached a predetermined time measured in advance in the design phase (Step S22). Then, when judged that the time elapsed after the passage of the tip end of the lamination target medium 22b has not reached the predetermined time (NO at Step S22), the control section 50 returns to Step S20 and continues the conveyance of the lamination target medium 22b.

Conversely, when the time elapsed after the passage of the tip end of the lamination target medium 22b has reached the predetermined time (YES at Step S22), the control section 50 stops the conveyance of the lamination target medium 22b via the conveyance roller driving section 52 (Step S24). Here, the tip end of the lamination target medium 22b stops just before it comes in contact with the standby conveyance roller pair 27a, with it being interposed between the two laminating films 22a and 22c as shown in FIG. 4. Since the lamination target medium 22b stops before it comes in contact with the standby conveyance roller pair 27a, a margin 60 for heat welding can be secured as shown in FIG. 4.

Next, the control section 50 drives the standby conveyance roller pair 27a, the conveyance roller pair 31, and the paper ejection roller pair 33 via the conveyance roller driving section 52 and the driving section for the standby conveyance roller pair 53 so as to convey the laminating films 22a and 22c in contact with the standby conveyance roller pair 27a and the lamination target medium 22b interposed therebetween to the fuser 5 integrally (Step S26). Here, since all of the four primary transfer rollers 15 are in a complete non-transfer mode where they are separated from the intermediate transfer belt 14 as described above, neither primary transfer nor secondary transfer is performed.

Accordingly, the laminating films 22a and 22c and the lamination target medium 22b interposed therebetween integrally pass through the standby conveyance roller pair 27a, the follower roller 17, and the secondary transfer roller 30 to be conveyed to the fuser 5. Then, they are heated and pressurized by the fuser 5 heated to a predetermined temperature so as to be bonded by compression, and pass through the conveyance roller pair 31 and the paper ejection roller pair 33 so as to be ejected to the paper ejection tray 32.

Next, the control section 50 judges whether the laminating films 22a and 22c and the lamination target medium 22b subjected to the lamination processing have been ejected to the paper ejection tray 32 (Step S28). When judged that they have not been ejected to the paper ejection tray 32 (NO at Step S28), the control section 50 returns to Step S26 and continues the conveyance of the laminating films 22a and 22c and the lamination target medium 22b.

Conversely, when judged that the laminating films 22a and 22c and the lamination target medium 22b have been ejected to the paper ejection tray 32 (YES at Step S28), the control section 50 stops the standby conveyance roller pair 27a, the conveyance roller pair 31, and the paper ejection roller pair 33 via the conveyance roller driving section 52 and the driving section for the standby conveyance roller pair 53 (Step S30).

Next, the control section 50 judges whether all lamination processing has been completed, or in other words, judges whether an instruction to perform lamination processing on a plurality of sheets has been given (Step S32). When judged that an instruction to perform lamination processing on a plurality of sheets has been given (NO at Step S32), the control section 50 returns to Step S14 and performs the next lamination processing by repeating the above-described operations.

As a result of this configuration, even when lamination processing is to be performed a number of times, the operator is only required to place the laminating films 22a and 22c on the paper feeding cassette 21a and the MPF tray 40 and place the lamination target media 22b on the paper feeding cassette 21b by a desired number of sheets, whereby lamination processing can be sequentially performed without manpower.

At Step S32, when judged that an instruction to perform lamination processing on a plurality of sheets has not been given (YES at Step S32), the control section 50 stops the heating of the fuser 5 using the fuser heating and controlling section 56 (Step S34), and ends the lamination processing.

In the above-described embodiment, once the laminating films 22a and 22c and the lamination target media 22b are set in an existing image forming apparatus, the series of processing operations is easily performed from the processing where the lamination target media 22b is interposed between the laminating films 22a and 22c to the lamination processing where bonding by compression is performed by heating and pressurizing. As a result, manpower can be significantly reduced in conjunction with the operation time can be shortened.

Also, in the above-described embodiment, the laminating films 22a and 22c are placed on the paper feeding cassette 21a and the MPF tray 40 provided in different housings, respectively. Therefore, as the laminating films 22a and 22c, individual laminating films having adhesive layers formed on one sides thereof can be used instead of a pair of films having a bonded edge.

Moreover, in the above-described embodiment, since lamination processing is performed using an existing image forming apparatus, an exclusive laminator is not required. Since no exclusive laminator is required, the cost can be reduced and space can be saved.

Furthermore, in the above-described embodiment, since tip ends of the lamination target media 22b are conveyed and stopped just before they come in contact with the standby conveyance roller pair 27a, a margin 60 for heat welding can be secured.

Still further, in the above-described embodiment, the laminating film 22a is conveyed through the conveyance path 24a by which it reaches the standby conveyance roller pair 27a from obliquely downward, the laminating film 22c is conveyed through a second conveyance path by which it reaches the standby conveyance roller pair 27a from obliquely downward on the opposite side of the conveyance path 24a, and the laminating films 22a and 22c are stopped by coming in contact with the standby conveyance roller pair 27a. Therefore, tip ends of the two laminating films 22a and 22c can be aligned. Also, the lamination target medium 22b passes between the first paper feeding path and the second paper feeding path, is conveyed through the conveyance path 24b by which it reaches the standby conveyance roller pair 27a, and is stopped just before it comes in contact with the standby conveyance roller pair 27a. As a result of this structure, the lamination target medium 22b can be automatically inserted between the two laminating films 22a and 22c.

Yet still further, during lamination processing in the above-described embodiment, the apparatus is in a complete non-transfer mode where no transfer of toner images is performed. As a result of this configuration, lamination processing can be easily performed even with an existing image forming apparatus.

In the above-described embodiment, a method has been adopted for the image forming apparatus 1 in FIG. 1 in which toner images primarily transferred to the intermediate transfer belt 14 are secondarily transferred to paper via the intermediate transfer belt 14. However, the present invention is not limited thereto and a method can be adopted in which toner images are directly transferred to paper.

While the present invention has been described with reference to the preferred embodiments, it is intended that the invention be not limited by any of the details of the description therein but includes all the embodiments which fall within the scope of the appended claims.

What is claimed is:

1. A laminating apparatus comprising:
a first accommodation section which accommodates a first laminating film;
a second accommodation section which accommodates a second laminating film;
a third accommodation section which accommodates a lamination target medium;
a heating and pressurizing section which is provided on a lower flow side with respect to a standby conveyance roller pair in a conveying direction; and
a conveying section which (i) conveys the first laminating film supplied from the first accommodation section and the second laminating film supplied from the second accommodation section until a tip end of the first laminating film and a tip end of the second laminating film come in contact with the standby conveyance roller pair, with the standby conveyance roller pair being stopped, (ii) conveys the lamination target medium supplied from the third accommodation section to an area between the first laminating film and the second laminating film in contact with and stopped by the standby conveyance roller pair, and (iii) drives the standby conveyance roller pair to convey the first laminating film, the second laminating film, and the lamination target medium interposed between the first laminating film and the second laminating film to the heating and pressurizing section.

2. A laminating apparatus comprising:
a first conveyance path for conveying a first accommodated object placed on a first accommodation section to a standby conveyance roller pair;
a second conveyance path for conveying a second accommodated object placed on a second accommodation section to the standby conveyance roller pair;
a third conveyance path for conveying a third accommodated object placed on a third accommodation section to the standby conveyance roller pair;
a heating and pressurizing section which is provided on a lower flow side with respect to the standby conveyance roller pair in a conveying direction; and
a control section which (i) conveys the first accommodated object, the second accommodated object, and the third accommodated object to the standby conveyance roller pair by the first conveyance path, the second conveyance path, and the third conveyance path, respectively, with the standby conveyance roller pair being stopped, in such a manner that at least a tip end of the second accommodated object is interposed between the first accommodated object and the third accommodated object, (ii) drives the standby conveyance roller pair after conveying the first accommodated object, the second accommodated object, and the third accommodated object to the standby conveyance roller pair, and (iii) conveys the first accommodated object, the third accommodated object, and the second accommodated object interposed between the first accommodated object and the third accommodated object to the heating and pressurizing section.

3. The laminating apparatus according to claim 2, wherein the first conveyance path conveys the first accommodated object placed on the first accommodation section to the standby conveyance roller pair such that a surface of the first accommodated object opposing a placement surface of the first accommodation section is oriented to a predetermined direction when the first accommodated object passes through the standby conveyance roller pair,
wherein the second conveyance path conveys the second accommodated object placed on the second accommodation section to the standby conveyance roller pair such that a surface of the second accommodated object opposing a placement surface of the second accommodation section is oriented to a same direction as the predetermined direction when the second accommodated object passes through the standby conveyance roller pair, and
wherein the third conveyance path conveys the third accommodated object placed on the third accommodation section to the standby conveyance roller pair such that a surface of the third accommodated object opposing a placement surface of the third accommodation section is oriented to a direction opposite to the predetermined direction when the third accommodated object passes through the standby conveyance roller pair.

4. The laminating apparatus according to claim 2, wherein the control section conveys the first accommodated object and the third accommodated object to the standby conveyance roller pair before conveying the second accommodated object to the standby conveyance roller pair.

5. The laminating apparatus according to claim 2, wherein the second conveyance path comprises a detection section which detects the tip end of the second accommodated object serving as a lamination target object, and
wherein the control section starts driving of the standby conveyance roller pair after a predetermined amount of time has elapsed from when the tip end of the second accommodated object is detected by the detection section.

6. The laminating apparatus according to claim 2, wherein the first accommodation section is arranged higher than the second accommodation section.

7. An image forming apparatus comprising:
a switching section which switches between a printing mode and a laminating mode;
a first conveyance path for conveying a first accommodated object placed on a first accommodation section to a standby conveyance roller pair;
a second conveyance path for conveying a second accommodated object placed on a second accommodation section to the standby conveyance roller pair;
a third conveyance path for conveying a third accommodated object placed on a third accommodation section to the standby conveyance roller pair;
a control section which drives the standby conveyance roller pair after conveying the first accommodated object, the second accommodated object, or the third accommodated object to the standby conveyance roller pair; and
a fixing section which is provided on a lower flow side with respect to the standby conveyance roller pair in a conveying direction,
wherein the control section, when a current mode is switched to the laminating mode by the switching section, (i) conveys the first accommodated object, the second accommodated object, and the third accommodated object to the standby conveyance roller pair by the first conveyance path, the second conveyance path, and the third conveyance path, respectively, with the standby conveyance roller pair being stopped, in such a manner that at least a tip end of the second accommodated object is interposed between the first accommodated object and the third accommodated object, (ii) conveys the first accommodated object, the second accommodated object, and the third accommodated object to the standby conveyance roller pair, and then (iii) conveys the first accommodated object, the third accommodated object, and the second accommodated object interposed between the first accommodated object and the third accommodated object to the fixing section.

8. The image forming apparatus according to claim 7, wherein the first conveyance path conveys the first accommodated object placed on the first accommodation section to the standby conveyance roller pair such that a surface of the first accommodated object opposing a placement surface of the first accommodation section is oriented to a predetermined direction when the first accommodated object passes through the standby conveyance roller pair,
wherein the second conveyance path conveys the second accommodated object placed on the second accommodation section to the standby conveyance roller pair such that a surface of the second accommodated object opposing a placement surface of the second accommodation section is oriented to a same direction as the predetermined direction when the second accommodation section passes through the standby conveyance roller pair, and
wherein the third conveyance path conveys the third accommodated object placed on the third accommodation section to the standby conveyance roller pair such that a surface of the third accommodated object opposing a placement surface of the third accommodation section is oriented to a direction opposite to the predetermined direction when the third accommodated object passes through the standby conveyance roller pair.

9. The image forming apparatus according to claim 7, wherein the control section conveys the first accommodated object and the third accommodated object to the standby conveyance roller pair before conveying the second accommodated object to the standby conveyance roller pair.

10. The image forming apparatus according to claim 7, wherein the second conveyance path comprises a detection section which detects the tip end of the second accommodated object serving as a lamination target object, and
wherein the control section starts driving of the standby conveyance roller pair after a predetermined amount of time has elapsed from when the tip end of the second accommodated object is detected by the detection section.

11. The image forming apparatus according to claim 7, wherein the first accommodation section is arranged higher than the second accommodation section.

12. The image forming apparatus according to claim 7, wherein the first accommodation section and the second accommodation section are paper feeding cassettes vertically arranged in two stages at a lower portion of an image forming section, and the third accommodation section is an openable manual feed tray provided on a side surface of the image forming apparatus.

13. The image forming apparatus according to claim 7, wherein the control section stops conveyance of a toner layer formed in an image forming section when the current mode is switched to the laminating mode by the switching section.

14. The image forming apparatus according to claim 7, wherein (i) a laminating film placed on the first accommodation section as the first accommodated object, (ii) a lamination target medium placed on the second accommodation section as the second accommodated object, and (iii) another laminating film placed on the third accommodation section as the third accommodated object are conveyed in the laminating mode.
